(19) United States
(12) Patent Application Publication
(10) Pub. No.: US 2002/0057205 A1
(43) Pub. Date: May 16, 2002

(54) METHOD AND APPARATUS FOR A REMOTELY SWITCHABLE POWER SUPPLY

(76) Inventor: CHARLES H. REYNOLDS, GILROY, CA (US)

Correspondence Address: LAW OFFICES OF JONATHAN ALAN QUINE, P O BOX 458, ALAMEDA, CA, 94501

(21) Appl. No.: 09/309,321

(22) Filed: May 11, 1999

(51) Int. Cl. H04Q 1/00

(52) U.S. Cl. 340/825; 340/693.1; 713/300

(57) ABSTRACT

One or more controlled power outlets placed on a power supply housing having the desirable characteristic that the height of the housing allows it to be mounted in a standard network device rack occupying one rack unit. To accomplish this configuration, controller power outlets are distributed on one surface of the housing, and sockets for receiving a control signal are distributed on a different surface. In various embodiments, one or more power sockets may be provided, and one or more power sockets may be controlled by signals received on each control socket.

### CROSS-REFERENCES TO RELATED APPLICATIONS

This application is related to the following design applications by the same inventor, each of which is incorporated herein by reference, and each of which was filed on the same day as this application:

REMOTELY SWITCHABLE POWER SUPPLY FOR NETWORK DEVICE RACKS HAVING EIGHT NETWORK PORTS AND FOUR POWER OUTLETS;

NETWORK REMOTELY SWITCHABLE POWER SUPPLY; AND

NETWORK PORT AND POWER OUTLET PLACED ON A SWITCHABLE POWER SUPPLY

### BACKGROUND OF THE INVENTION

This invention relates to electronic circuits. More particularly, the invention relates to a method and apparatus for a power supply and housing that is particularly appropriate for use in rack-style network equipment.

Early in the development of modem networking equipment such as routers, it was realized that at times a particular piece of network equipment might hang or “crash.” In such instances, a human operator often had to intervene by traveling to the location of the equipment and rebooting or power cycling the equipment in order to get that particular piece of equipment working.

Responding to these needs, the inventor of the present invention, as early as 1994, constructed a “power cycle box.” The original design contained two network ports and a control relay connected to at least one power outlet. From the exterior, the supply arranged two network socket connections and a power outlet socket on the same surface of the power supply (the front or the top), and in some instances included an indicator light. A diagram of such a design is shown in FIG. 1. In this design, a particular network signal could be sent through the two network ports which would cause the control relay to disconnect the power supply from the power outlet, thereby, shutting off power to the controlled network device. Another signal would reestablish power, thereby, causing the controlled device to reboot. An alternative design arranged more than one controlled power supply socket with corresponding network sockets on a surface of the power supply.

While this design proved both useful and successful in the marketplace, for many years a need has been felt for a more compact and streamlined design that could be fitted efficiently into a standard network rack. However, it is difficult to construct such a design because of the restrictions on placement of elements within the control circuit, which must be sufficiently far apart to provide clearance between the network data connections and the AC power connections to prevent electromagnetic interference. An additional desired feature was for multiple controlled power supplies.

What is needed, therefore, is a power cycle control circuitry that can fit into a small space such as a single rack unit, while allowing for independent control of multiple power outlets.

### SUMMARY OF THE INVENTION

According to the invention, one or more controlled power outlets are housed in a power supply housing, the housing having the desirable characteristic that the height of the housing allows it to be mounted in a standard network device rack occupying one rack unit. To accomplish this configuration, controller power outlets are distributed on one surface of the housing, and sockets for receiving a control signal are distributed on a different surface. In various embodiments, one or more power sockets may be provided, and one or more power sockets may be controlled by each control signal socket.

### BRIEF DESCRIPTION OF THE DRAWINGS

FIG. 1 is a diagram of a housing and controlled power supply according to the prior art.

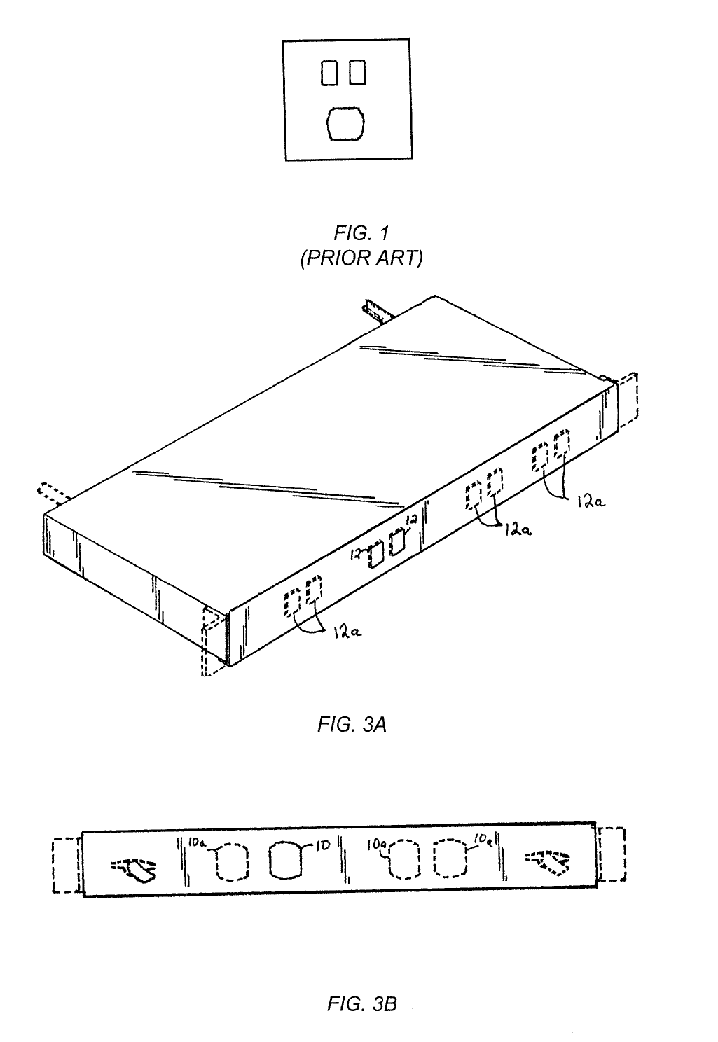

FIG. 2 is a simplified block diagram showing functional elements of one specific embodiment of the present invention for one controlled circuit.

FIGS. 3A and 3B are different views of a diagram of a housing according to the invention.

FIGS. 4A and 4B are different views of a sketch of a housing according to a specific embodiment of the invention, showing measurements in inches for a specific embodiment.

### DESCRIPTION OF THE SPECIFIC EMBODIMENTS

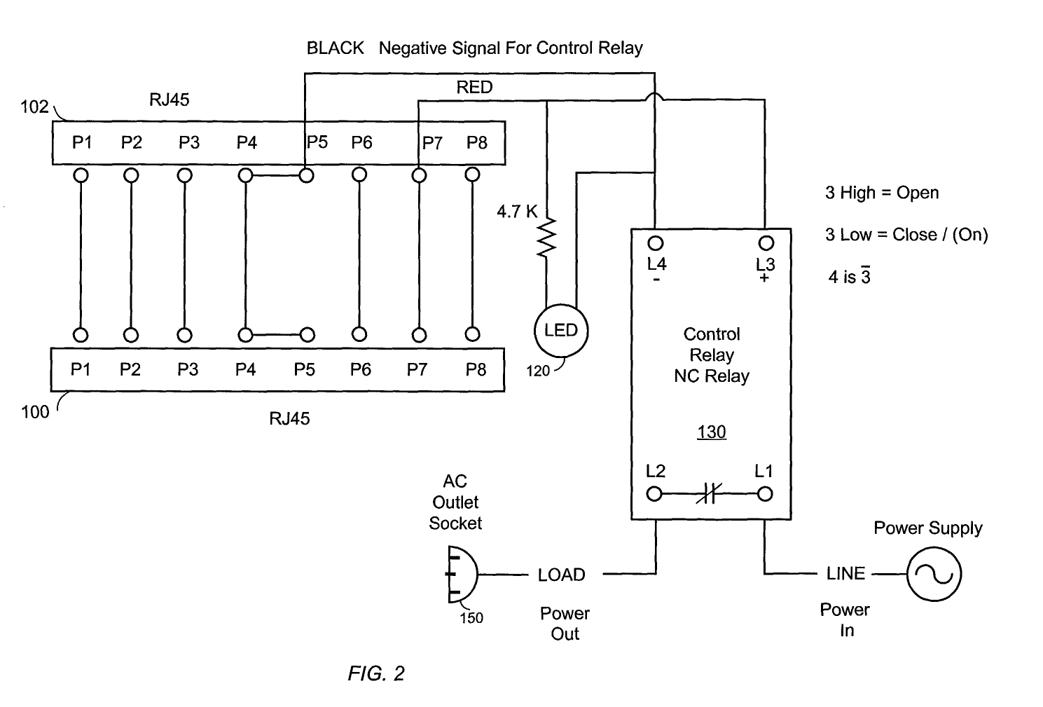

FIG. 2 is a simplified block diagram showing functional elements of one specific embodiment of the present invention for one controlled circuit. Shown are control sockets 100 and 102, which in one specific embodiment are standard RJ45 network sockets having pins as shown, LED 120, control relay 130. According to one embodiment of the invention, a network connection is made through sockets or receptacles 100 and 102 and in standard network data transmission, data passes through the connections without being affected by the circuits of the invention.

However, when a controlling network device such as a router wishes to cause a power cycle to the load connected to AC outlet 150, the controlling network device places a predefined signal on pin 7 and alternatively also on pin 4 or 5. The signal from pin 7 connects to pin 3 which when forced to the low state causes control relay 130 to open thereby disconnecting the power supply line from the load line and removing power from AC outlet 150. At the same time, according to one embodiment of the invention, an opposite signal is placed on pins 4 or 5 causing control relay L4 to go to a high state which also forces control relay 130 to disconnect the power supply line from the loaded AC outlet.

LED 120 is an optional indicator light that may be variously connected to indicate when outlet 150 is on or off.

In an alternative embodiment, control relay 130 is normally in the open position disconnecting the power supply line from the load line, and a specific signal on a pin of the sockets must be asserted to close the relay and thereby connect the power supply.

It will be obvious to those of skill in the art that the control signal for AC outlet 150 can also be delivered through a single control socket such as 102. However, this is a less desirable alternative embodiment because it would require a dedicated line from the controlling network device to the power supply, rather than the pass-through network connection as illustrated in FIG. 2.

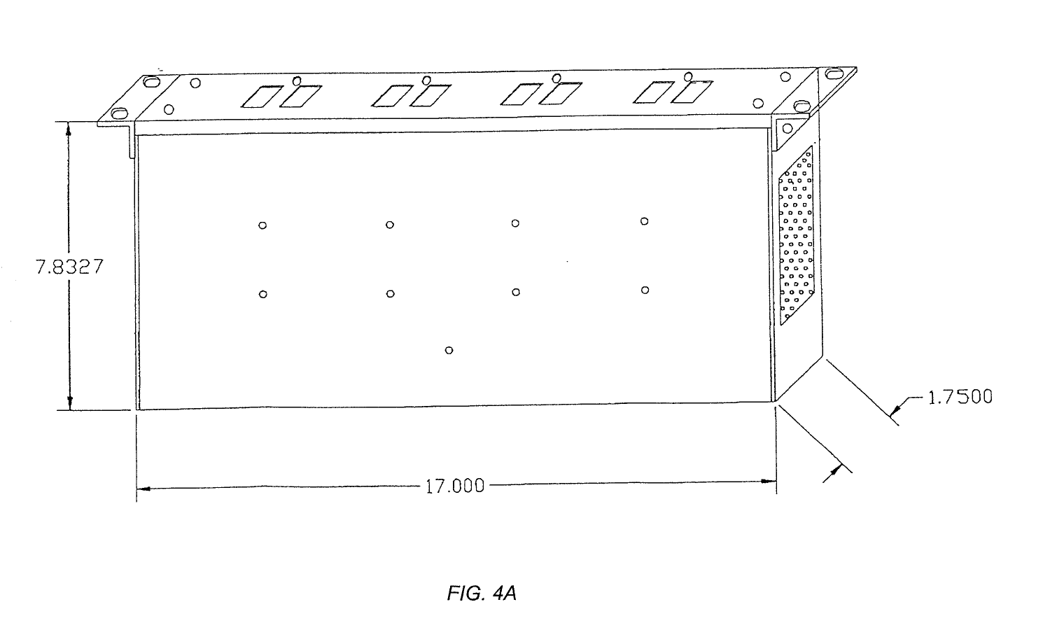

According to the invention, one or more controlled power supplies can be housed in a power supply housing as shown in FIGS. 3A and 3B. The housing shown in FIG. 3 has the desirable characteristic that the height (h) of the housing is such that the housing can be mounted in a standard network device rack and will occupy only one rack unit. As is known in the art, one rack unit in one well-known device standard is 1.75 inches. FIG. 3 shows an embodiment having one switchable power outlet 10 on one side and two network sockets 12 that provide control for that outlet on the other side. These elements are drawn in solid lines. As discussed above, control of outlet 10 can alternatively be accomplished through just one socket 12.

In an alternative embodiment, additional power sockets 10a may be provided. Some or all of these additional sockets may be controlled by the same network socket 12. Alternatively, some or all of the additional power sockets may be separately controlled by additional network sockets 12a.

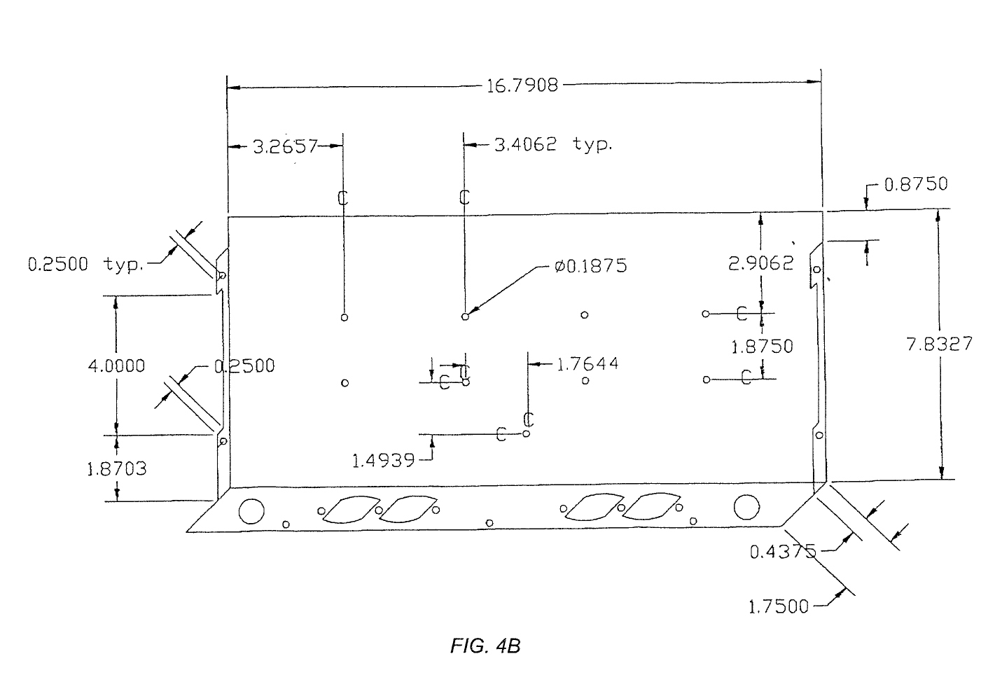

FIGS. 4A and 4B are different views of a sketch of a housing according to a specific embodiment of the invention, showing measurements in inches for a specific embodiment.

The invention has now been explained with regard to specific embodiments. Other embodiments would be obvious to those with skill in the art, and the invention should not be limited except as provided in the attached claims.

What is claimed is:

1. A controllable power supply comprising:
a housing having at least two distinguishable surfaces;
a first control signal socket located on a first of said distinguishable surfaces;
a power supply socket located on a second of said distinguishable surfaces;
control circuitry within said housing operatively connected with said control signal socket, and said power supply socket wherein power to said power supply socket may be turned on or off in response to a signal received at said control signal socket.

2. The device according to claim 1, further comprising:
a power line for connecting to an external power source.

3. The device according to claim 1, further comprising:
a second control signal socket for passing through signals received on said first control signal socket.

4. The device according to claim 1, further comprising:
an indicator light operatively connected to said control circuitry for indicating whether power to said power supply socket is turned on or off.

5. The device according to claim 1, wherein said control circuitry comprises a control relay.

6. The device according to claim 1 wherein said first and second distinguishable surfaces are parallel to each other.

7. The device according to claim 1 wherein said housing constitutes a box comprising six surfaces.

8. The device according to claim 7 wherein said housing comprises a top surface, a bottom surface, a front surface, a rear surface, a left surface, and a right surface.

9. The device according to claim 8, wherein said control socket is located on said front surface and said power supply socket is located on said rear surface.

10. The device according to claim 8, further comprising:
a plurality of paired control sockets located on said front surface and each associated with one or more power supply sockets located on said rear surface.

11. The device according to claim wherein said top surface and said bottom surface are parallel planes between 1.5 and 2.0 inches apart.

12. The device according to claim 9, wherein housing is mountable in a computer device rack and occupies only one rack unit.

13. A method for a controllable power supply wherein sockets and control circuitry may be contained within a housing having a constrained height comprising:
placing a control signal socket on one surface of said housing;
placing a power supply outlet on an opposite surface of said housing; and
placing control circuitry within said housing, said control circuitry operatively connected with said control signal socket and said power supply socket wherein power to said power supply socket may be turned on or off in response to a signal received at said control signal socket.
